(19) United States
(12) Patent Application Publication
(10) Pub. No.: US 2026/0303557 A1
(43) Pub. Date: Oct. 1, 2026

(54) INTELLIGENT FILTERING OF FLAGGED ELECTRONIC COMMUNICATIONS USING MACHINE LEARNING

(71) Applicant: RAYMOND JAMES FINANCIAL, INC., Saint Petersburg, FL (US)

(72) Inventors: Satish Immanuel Anjilvel, Saint Petersburg, FL (US); Samuel John Schultz, Saint Petersburg, FL (US); Stuart Feld, Saint Petersburg, FL (US); Peter Stephen Greve, Saint Petersburg, FL (US)

(21) Appl. No.: 19/092,901

(22) Filed: Mar. 27, 2025

(51) Int. Cl. H04L 51/212; G06F 40/237; G06N 20/00

(52) U.S. Cl. CPC H04L 51/212; G06F 40/237; G06N 20/00

(57) ABSTRACT

Systems, methods, and computer-readable media are disclosed for systems and methods for intelligent filtering of flagged electronic communications using machine learning. Example methods include determining a first flagged electronic communication using a first machine learning model, where the first flagged electronic communication is flagged due to presence of a phrase, determining, using a second machine learning model, a first false positive score of the first electronic communication, and determining that the first false positive score is less than or equal to a first threshold. The method may include generating a manual review notification for the first flagged electronic communication, determining a manual review output signal associated with the first flagged electronic communication, and causing the second machine learning model to be retrained based at least in part on the manual review output signal.

### BACKGROUND

Electronic communications, such as email messages, text messages, and other electronic messages may be reviewed and flagged for various reasons, such as inclusion of certain words or phrases. Such review and flagging may be performed using one or more automated systems. For example, prohibited words or phrases may be automatically flagged for violating organizational policies. Moreover, synonyms, misspellings, and so forth of prohibited words or phrases may be flagged as well. However, depending on sensitivity settings and the chance that a certain word or phrase could also be used for legitimate purposes may lead to false positives of flagged communications, resulting in a large volume of electronic communications that are to be reviewed manually. Accordingly, intelligent filtering of flagged electronic communications using machine learning may be desired.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral may identify the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is a schematic illustration of an example use case for intelligent filtering of flagged electronic communications using machine learning in accordance with one or more example embodiments of the disclosure.

FIG. 2 is a schematic illustration of an example process flow for intelligent filtering of flagged electronic communications using machine learning in accordance with one or more example embodiments of the disclosure.

FIGS. 3-4 schematically illustrate an example data flow and machine learning model inputs and outputs for intelligent filtering of flagged electronic communications using machine learning in accordance with one or more example embodiments of the disclosure.

FIG. 5 is a schematic illustration of example user interfaces and an example process flow for determining whether to present notifications in accordance with one or more example embodiments of the disclosure.

FIG. 6 is a schematic block diagram of an illustrative computer system in accordance with one or more example embodiments of the disclosure.

### DETAILED DESCRIPTION

### Overview

Automated classification of data, such as electronic communication content, can be time consuming and difficult, particularly when variations of certain words, phrases, emojis, and other content can be subject to syntax and/or contextual interpretation. For example, even in instances where computer systems are used to automatically flag certain content in electronic communications, a rate of false positives may be high, which, when dealing with millions of messages or other communications, can lead to hundreds of thousands of flagged electronic communications for manual review. False positive rates can be as high as 95+% or in some instances 99+%. Such false positive rates may be unmanageable and/or cumbersome for manual review.

Electronic communications can include emails, texts, direct messages, ephemeral content, and/or other types of electronic communications. Certain systems may be configured to automatically detect and flag words, phrases (e.g., groups of words, words appearing in certain proximity to one another, etc.), or other characters (e.g., text-based characters, emojis, etc.) in electronic communications. Flagged communications may then be manually processed for final determination as to whether the communication is a prohibited communication or otherwise violates one or more organizational policies.

Embodiments of the disclosure address these issues by providing a robust system to detect prohibited communications, as well as by reducing the number of electronic communications falsely flagged, thereby reducing the number of communications to be reviewed manually. To provide a more robust system to detect prohibited communications, embodiments may use various algorithms, such as large language models, to generate synthetic text that mirrors actual prohibited text, where the synthetic text can be used in addition to the actual prohibited text to train a machine learning model. The trained machine learning model can then be deployed to detect prohibited electronic communications with greater accuracy and a reduced number of false positives. Moreover, embodiments may deploy another machine learning model to determine a false positive score for a particular flagged communication, where the false positive score can be used to determine whether the particular flagged communication should be queued for manual review. Some embodiments may use a single machine learning model, while other embodiments may use more than two machine learning models. In addition, embodiments may use outputs from human classification, such as manual operator review signals, to retrain one or more machine learning models and improve performance over time. Due to the lightweight nature of the machine learning algorithms and/or content processing algorithms described herein, content can be processed at runtime (e.g., when electronic messages are transmitted, or shortly thereafter, etc.), and can be processed using one or more models to determine whether to flag any electronic communications.

Some embodiments may be deployed in conjunction with, or instead of, lexicon-based rules that match keyword patterns. However, such rules may lead to a high volume of messages or phrases that trigger the rule but often pose no risk and are therefore false positives. By including machine learning models into a processing flow, lexicon-based rules can be supplemented with machine learning models to reduce false positive identification of messages. For example, the machine learning model may be configured to determine the true context or meaning of electronic communications, which allows for more accurate determination of electronic communication that may pose a risk and/or violate a policy.

Certain embodiments may include multi-tiered machine learning algorithms, in which a first machine learning algorithm identifies possible electronic communications for flagging, and a second machine learning algorithm generates false positive scores to filter the flagged electronic messages to reduce overall volume for manual review. A feedback loop may be used to continually improve accuracy of the machine learning model(s), which may include feedback from manual operators or other users. In some embodiments, a rules-based model or other type of model, such as a lexicon-based model, may be used instead of, or in addition to, a machine learning model.

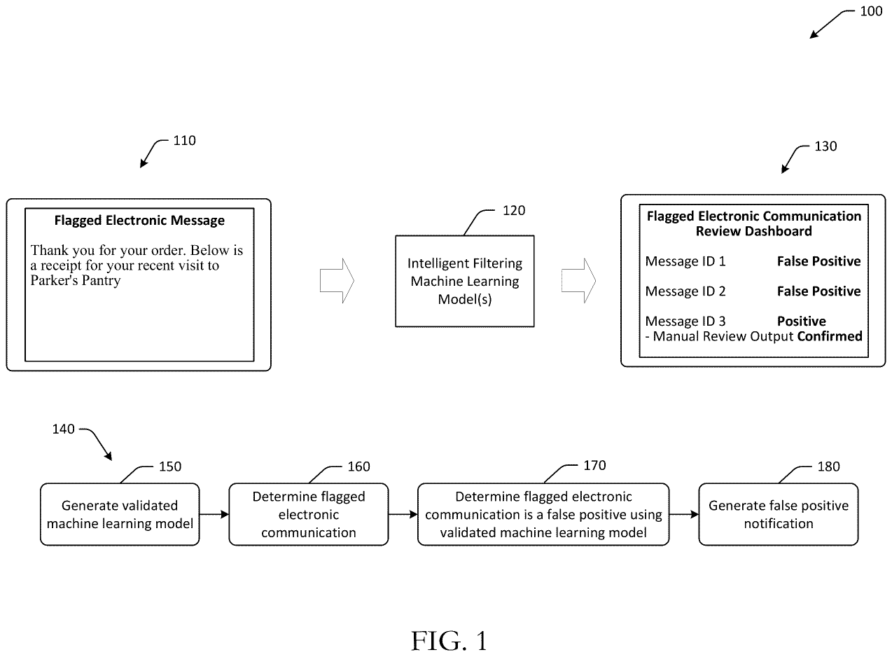

Referring to FIG. 1, an example use case 100 for intelligent filtering of flagged electronic communications using machine learning is depicted in accordance with one or more example embodiments of the disclosure. For example, at a first user interface 110 presented at a user device in FIG. 1, an example flagged electronic message is depicted. The electronic message may be flagged due to a number of lexicon-based rules. For example, although the message content is “Thank you for your order. Below is a receipt for your recent visit to Parker's Pantry,” which a human may clearly identify as a false positive, the system may have flagged the electronic communication anyway. For example, the rules may include certain lexicon-based rules, such as (Your or UR or “U R”) FOLLOWED BY~3 ((order NPB(in) ) or orders or trade or trades or transaction or transactions) FOLLOWED BY~5 (executed or received or receipt or filled) FOLLOWED BY~[within 4 words]. Such rules may have been instituted to flag a message along the lines of “Thank you for your order today. The transaction was entered and will be filled at market closing due to the fact that it is a mutual fund.” Although the depicted message is not actually a communication that should be flagged, due to the lexicon-based rules, the electronic communication was nonetheless flagged, and would typically need to be manually reviewed and cleared.

Embodiments may deploy an intelligent filtering machine learning model 120 that can be used to identify false positive electronic communications, such as that in the first user interface 110, and reduce the overall number of electronic communications for manual review. The intelligent filtering machine learning model 120 may be stored at a remote server and may be executed to determine whether a flagged electronic communication is a false positive. For example, the intelligent filtering machine learning model 120 may be executed by a computing system to analyze the electronic communication and to output one or more notifications. If a probability value or confidence score indicating that the electronic communication is found to be a false positive, the electronic communication may be cleared, and if not, the electronic communication may be flagged and a notification may be presented to a user for manual review.

For example, as depicted at a second user interface 130, an example flagged electronic communication review dashboard depicts three messages, two of which were manually confirmed to be false positives, and the third that was an actual positive. Such manual review output data may be used to retrain the intelligent filtering machine learning model 120 and improve performance.

To determine whether to flag an electronic communication for manual review, an example process flow 140 is presented and may be performed, for example, by one or more remote servers. The remote server and/or computer system may include at least one memory that stores computer-executable instructions and at least one processor configured to access the at least one memory and execute the computer-executable instructions to perform various actions or operations, such as one or more of the operations in the process flow 140 of FIG. 1.

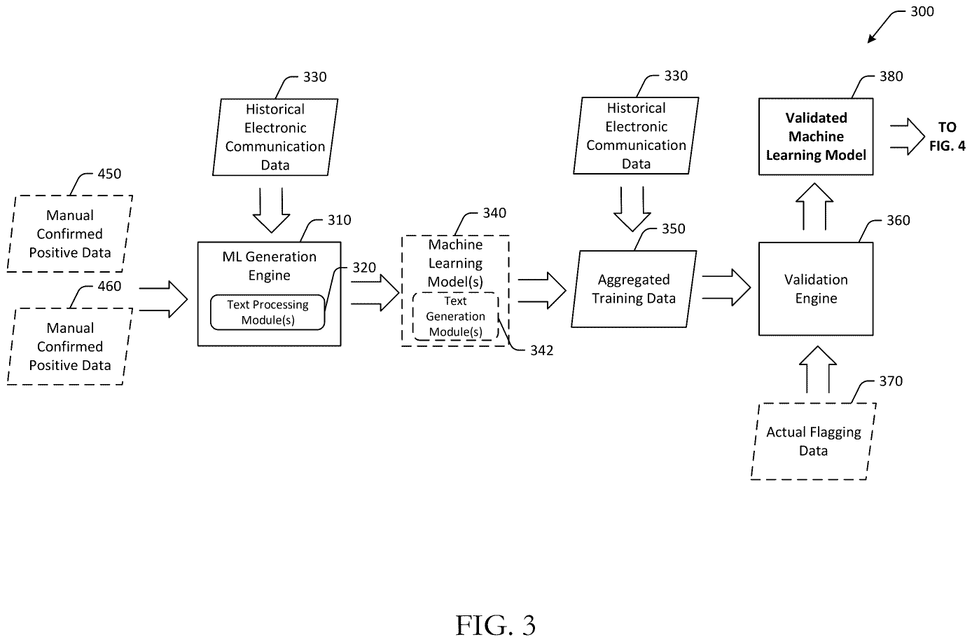

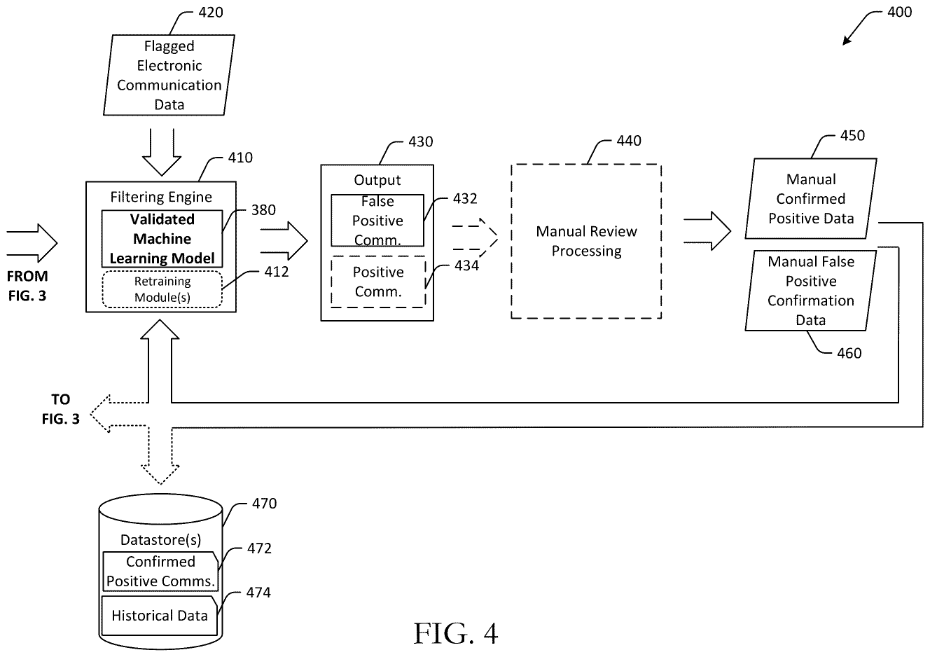

At block 150, a validated machine learning model may be generated. For example, a machine learning model to process electronic communications may be generated and validated using synthetically generated sample text, as discussed in more detail with respect to FIGS. 3-4. At block 160, a flagged electronic communication may be determined. For example, the machine learning model may be used to determine electronic message content, and communications with certain meanings may be flagged for manual review. At block 170, it may be determined that the flagged electronic communication is a false positive using the validated machine learning model and/or a different machine learning model. For example, certain embodiments may use one or more machine learning modules or algorithms to determine whether a meaning of the content of an electronic message is in violation of one or more policies, instead of a mere rules-based system. In some instances, scores, such as confidence scores, as to whether an electronic communication is a false positive may be determined and compared to a threshold to determine whether to clear the message or not. At block 180, a false positive notification may be generated. Because the electronic communication was a false positive, the system may generate a false positive notification and clear the communication and/or send a notification to a manual operator in case the manual operator desires to review. User feedback, for example from manual review or after presenting notifications, may be used as a feedback loop to improve accuracy of the intelligent filtering machine learning model 120.

Example embodiments of the disclosure provide a number of technical features or technical effects. For example, in accordance with example embodiments of the disclosure, certain embodiments of the disclosure may automatically analyze content of electronic messages to determine whether a meaning of the content is to be manually reviewed. Certain embodiments may recognize or identify presence of certain content using one or more machine learning modules or algorithms. As a result of improved functionality, content may be accurately flagged for manual review and an amount of false positives may be reduced. Embodiments of the disclosure may improve computing efficiency and bandwidth by extracting feature data from content. The above examples of technical features and/or technical effects of example embodiments of the disclosure are merely illustrative and not exhaustive.

One or more illustrative embodiments of the disclosure have been described above. The above-described embodiments are merely illustrative of the scope of this disclosure and are not intended to be limiting in any way. Accordingly, variations, modifications, and equivalents of embodiments disclosed herein are also within the scope of this disclosure. The above-described embodiments and additional and/or alternative embodiments of the disclosure will be described in detail hereinafter through reference to the accompanying drawings.

### Illustrative Process and Use Cases

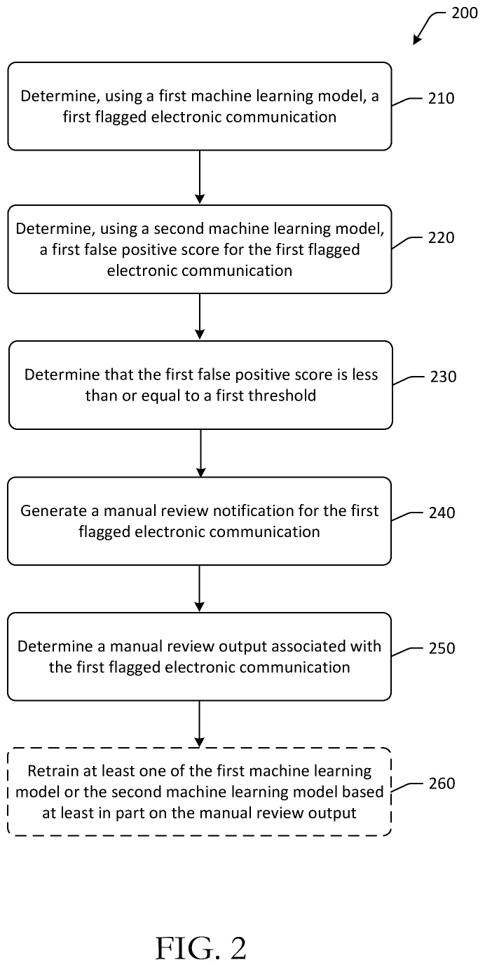

FIG. 2 depicts an example process flow 200 for intelligent filtering of flagged electronic communications using machine learning in accordance with one or more example embodiments of the disclosure. While example embodiments of the disclosure may be described in the context of emails and/or text messages, it should be appreciated that the disclosure is more broadly applicable to any type of electronic communication. Some or all of the blocks of the process flows in this disclosure may be performed in a distributed manner across any number of devices. The operations of the process flow 200 may be optional and may be performed in a different order.

At block 210 of the process flow 200, computer-executable instructions stored on a memory of a device, such as a remote server or a user device, may be executed to determine a first flagged electronic communication using a first machine learning model. For example, a remote server may determine a first flagged electronic communication using a first machine learning model. The first machine learning model may be used to review contents of electronic messages in real-time, periodically, or during another cadence. The first machine learning model may be configured to determine whether or not to flag an electronic communication for manual review. In some embodiments, the first flagged electronic communication may be flagged due to presence of a phrase. For example, the remote server may extract text from the communication and determine a meaning associated with the text. The meaning may be an intended meaning, in the event of misspellings, abbreviations, and/or emoji use. The first machine learning model may be used to determine the presence of a certain phrase or an equivalent of a phrase, and may therefore determine that the first electronic communication is to be flagged. Other embodiments may analyze the text of a phrase and/or other factors to determine whether to flag an electronic communication.

At block 220 of the process flow 200, computer-executable instructions stored on a memory of a device may be executed to determine, using a second machine learning model, a first false positive score of the first electronic communication. For example, a remote server may determine, using a second machine learning model, a first false positive score of the first electronic communication. The second machine learning model may be used to determine a likelihood that the first flagged electronic communication is accurately categorized and/or if the first flagged electronic communication is likely a false positive. In doing so, the system may reduce the overall number of false positives flagged. As a result, manual operator review may be directed to a reduced number of flagged communications. The second machine learning model may be configured to generate one or more scores, such as a false positive score indicative of a likelihood that the first flagged electronic communication is a false positive and was inaccurately flagged. The score may be determined based at least in part on a number of factors, such as the source and/or recipient of the communication, organizational roles of the source and/or recipient, the content of the communication, the meaning of the content, and so forth.

At block 230 of the process flow 200, computer-executable instructions stored on a memory of a device may be executed to determine that the first false positive score is less than or equal to a first threshold. For example, a remote server may determine that the first false positive score is less than or equal to a first threshold. This may indicate that the message or communication is likely not a false positive, and was correctly categorized by the first machine learning model. In some embodiments, the first threshold may be configurable and/or dynamic. For example, in one embodiment, the first threshold may be determined based at least in part on the phrase. For example, certain phrases (or analogous phrases as determined by the first machine learning model and/or second machine learning model) may have a lower threshold than others depending on the potential negative impact of the phrase. In this example, the lower the first threshold, the less important or impactful the phrase. If the second machine learning model is determining a different score, such as a likelihood that the phrase or message is correctly flagged, the higher the threshold, the higher the importance or impact of the phrase. Some embodiments may determine the first threshold based at least in part on words in the phrase, rather than the phrase as a whole. For example, the remote server may determine the first threshold based at least in part on words in the phrase, where individual words or characters can have relatively higher weight in determination. In another example, the first threshold may be determined based on the user profiles of users involved, such as the sender, recipient, and/or copied parties. For example, the historical violations of users may be considered when determining whether to flag a message. The remote server may therefore determine the first threshold based at least in part on a user profile associated with the first flagged electronic communication. In another example, the remote server may determine the first threshold based at least in part on a number of flagged electronic communications queued for manual review, where the threshold may be dynamically shifted based at least in part on a backlog for manual review, if any.

At block 240, computer-executable instructions stored on a memory of a device may be executed to generate a manual review notification for the first flagged electronic communication. For example, the remote server may generate a manual review notification for the first flagged electronic communication. The notification may include a request for manual review of the first flagged electronic communication. One or more notifications may be presented at a review dashboard for manual review and confirmation as to whether or not the message was correctly flagged.

At block 250, computer-executable instructions stored on a memory of a device may be executed to determine a manual review output signal associated with the first flagged electronic communication. For example, the remote server may determine a manual review output signal associated with the first flagged electronic communication. In some embodiments, a positive signal may indicate the communication was correctly flagged, and a negative signal may indicate the communication was incorrectly flagged, or is otherwise a false positive. For example, the remote server may determine that the manual review output signal indicates the first flagged electronic communication is a false positive.

At optional block 260, computer-executable instructions stored on a memory of a device may be executed to cause at least one of the first machine learning model or the second machine learning model to be retrained based at least in part on the manual review output signal. For example, the remote server may cause the second machine learning model to be retrained based at least in part on the manual review output signal. In some embodiments, the remote server may periodically retrain the first machine learning model and/or the second machine learning model using the manual review output signals to improve accuracy and performance.

FIGS. 3-4 schematically illustrate an example data flow and machine learning model inputs and outputs for intelligent filtering of flagged electronic communications using machine learning in accordance with one or more example embodiments of the disclosure. Different embodiments may include different, additional, or fewer inputs or outputs than those illustrated in the examples of FIGS. 3-4.

In FIG. 3, an example data flow 300 is schematically depicted. A machine learning model generation engine 310 may be configured to extract and/or process video, audio, and/or text components of electronic communications. In some embodiments, the machine learning model generation engine 310 may be configured to detect or determine one or more features present in electronic communications. The machine learning model generation engine 310 may be stored at and/or executed by one or more remote servers. The machine learning model generation engine 310 may include one or more modules or algorithms, and may be configured to generate and/or optimize an optional machine learning model 340. The machine learning model 340 may be configured to flag messages or electronic communications that are potentially in violation of one or more organizational rules.

For example, the machine learning model generation engine 310 may include one or more text processing modules 320. Additional or fewer, or different, modules may be included. The text processing modules 320 may be configured to analyze and/or process text content, such as text included in electronic communications. The text processing modules 320 may include one or more natural language processing modules or algorithms and may be configured to detect or determine the presence of features such as certain words or phrases, themes, sentiment, topics, and/or other features. The text processing modules 320 may be configured to perform semantic role labeling, semantic parsing, or other processes configured to assign labels to words or phrases in a sentence that indicate the respective word or phrase's semantic role in a sentence, such as object, result, subject, goal, etc. Semantic role labeling may be a machine learning or artificial intelligence based process. Text processing modules 320 may include one or more algorithms configured to detect a meaning of text-based sentences.

The machine learning model generation engine 310 may receive one or more inputs that can be used to generate or optimize the machine learning model 340. For example, the machine learning model generation engine 310 may receive one or more of historical electronic communication data 330 associated with previously processed electronic communications. The machine learning model generation engine 310 may generate the machine learning model 340. Other optional inputs include manual confirmed positive data 450 and manual false positive data 460, as discussed with respect to FIG. 4.

The machine learning model 340 may include one or more text generation modules 342 that are configured to generate text. For example, in some embodiments, the historical electronic communication data 330 may be actual communications that have been sent or received by users. In some instances, the machine learning model 340 may be configured to generate synthetic text that can be used as additional training data for validation of the machine learning model 340. For example, the machine learning model 340 may use a large language model to generate additional synthetic true positive examples. For example, the large language model can be provided with the existing examples and prompted to generate a variety of sentences suggestive of a violation of the relevant organizational policy. The text can then be added to randomly chosen false lexicon positive messages, converting these messages into synthetic true lexicon positives. A statistical analysis of the word distributions of the synthetic messages can be performed to confirm that the synthetic messages are adequately similar to the authentic positive messages. The machine learning model 340 may therefore output aggregated training data 350, which may include the synthetically generated messages and/or electronic communications, in addition to the historical electronic communication data 330.

In one example, a remote server may determine a first set of manually reviewed positive flagged electronic communications, generate a set of synthetic phrases based at least in part on the first set of manually reviewed positive flagged electronic communications, and train the first machine learning model using a blended data set (e.g., aggregated training data 350, etc.) that includes the first set of manually reviewed positive flagged electronic communications and the set of synthetic phrases. The set of synthetic phrases can be generated using a large language model.

The aggregated training data 350 may be input at a validation engine 360, which may be used to determine whether performance of the machine learning model 340 can be validated. The validation engine 360 may optionally receive an input of actual flagging data 370 as it relates to the historical electronic communication data 330, and may be configured to test performance of the machine learning model 340 on data not used to train the machine learning model 340. The validated machine learning model may be output 380 for deployment.

In FIG. 4, the validated machine learning model 380 may be deployed in a filtering engine 410. The filtering engine 410 may be configured to ingest flagged electronic communication data 420 and generate one or more outputs 430. The flagged electronic communication data 420 may be from any suitable channel, such as email communication, text message communication, direct message communication, or another channel. The flagged electronic communication data 420 may include the content of messages that have been flagged as potentially violating an organizational policy or another reason.

Using one or more algorithms or modules, the filtering engine 410 may determine the one or more outputs 430, such as a false positive communication signal 432 and an optional actual positive communication signal 434. The false positive communication signal 432 may indicate the flagged communication is a false positive (or likely a false positive, etc.), and the actual positive communication signal 434 may indicate that the flagged communication is likely not a false positive and/or merits manual review.

The outputs 430 may be input at an optional manual review processing workflow 440, where positive communications (or communications with a likelihood of being false positive lower than a threshold), may be queued for manual review. Signals from manual review output may be determined and used to improve model and filtering performance. For example, a manual reviewer may generate manual confirmed positive data 450 and/or manual false positive confirmation data 460. Such data may be stored in one or more datastore(s) 470, such as confirmed positive communications 472, historical data 474, and so forth. The manual confirmed positive data 450 and/or manual false positive confirmation data 460 may also be ingested into the filtering engine 410, which may include one or more retraining modules 412 that can be used to refine and/or optimize filtering engine performance. In addition, the manual confirmed positive data 450 and/or manual false positive confirmation data 460 may be ingested into the machine learning model generation engine 310 to train new models, retrain existing models, generate new models, and so forth based on actual user or manual reviewer feedback.

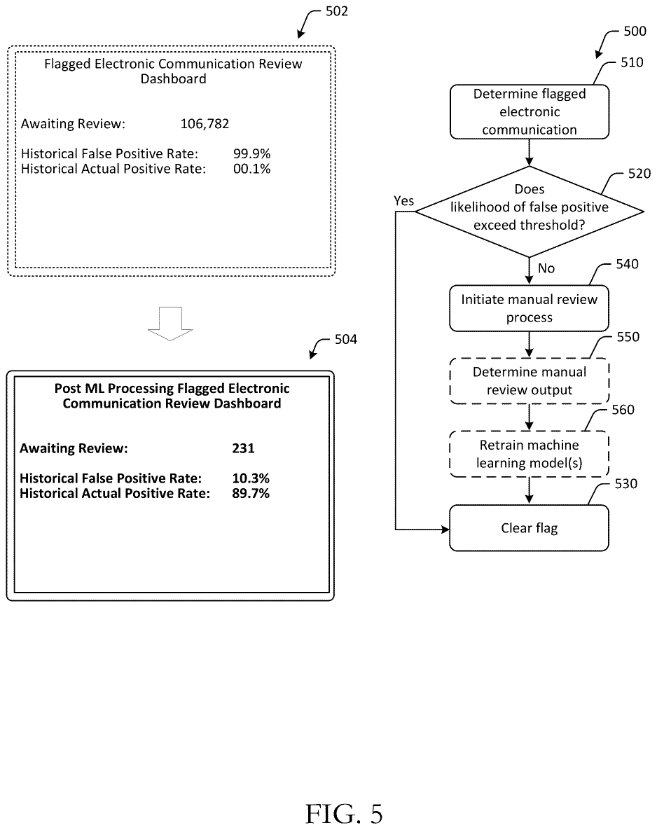

FIG. 5 is a hybrid schematic illustration of example user interfaces and an example process flow 500 for determining whether to present notifications in accordance with one or more example embodiments of the disclosure. While example embodiments of the disclosure may be described in the context of user interfaces and electronic communications, it should be appreciated that the disclosure is more broadly applicable to any suitable type of electronic communication, such as text, voice, audio, and so forth. Some or all of the blocks of the process flows in this disclosure may be optional and may be performed in a distributed manner across any number of devices. The operations of the process flow 500 may be performed in a different order. The process flow 500 may be executed to determine whether to present a notification for certain segments of content.

In FIG. 5, the example process flow 500 may include block 510 at an electronic communication may be flagged for manual review. The communication may be flagged automatically using a first machine learning model that processes the content of the electronic communication. At determination block 520, the system may determine whether the likelihood the communication was flagged as a false positive exceeds a threshold. The remote server may determine a likelihood the communication is a false positive using a second machine learning model, and may determine whether the likelihood satisfies a threshold. If the likelihood exceeds or otherwise satisfies the threshold, this may indicate the message is probably a false positive, and the process may end at block 530, at which the communication may be cleared from the queue and/or the flag removed.

If the likelihood does meet or exceed the threshold at determination block 520, the process may continue to block 540 at which a manual review process may be initiated. For example, a notification for manual review or other action item can be generated. At optional block 550, a manual review output may be determined, and at optional block 560, one or more machine learning models may be retrained based on the manual review output. The process flow 500 may then end at block 530, where the communication is handled manually and the flag is cleared.

In one embodiment, the remote server may be configured to determine a second flagged electronic communication using the first machine learning model, determine, using the second machine learning model, a second false positive score of the second electronic communication, determine that the second false positive score is greater than the first threshold, and generate a false positive notification for the second flagged electronic communication.

One or more operations of the methods, process flows, or use cases of FIGS. 1-5 may have been described above as being performed by a user device, or more specifically, by one or more program module(s), applications, or the like executing on a device. It should be appreciated, however, that any of the operations of the methods, process flows, or use cases of FIGS. 1-5 may be performed, at least in part, in a distributed manner by one or more other devices, or more specifically, by one or more program module(s), applications, or the like executing on such devices. In addition, it should be appreciated that the processing performed in response to the execution of computer-executable instructions provided as part of an application, program module, or the like may be interchangeably described herein as being performed by the application or the program module itself or by a device on which the application, program module, or the like is executing. While the operations of the methods, process flows, or use cases of FIGS. 1-5 may be described in the context of the illustrative devices, it should be appreciated that such operations may be implemented in connection with numerous other device configurations.

The operations described and depicted in the illustrative methods, process flows, and use cases of FIGS. 1-5 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 1-5 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

### Illustrative Device Architecture

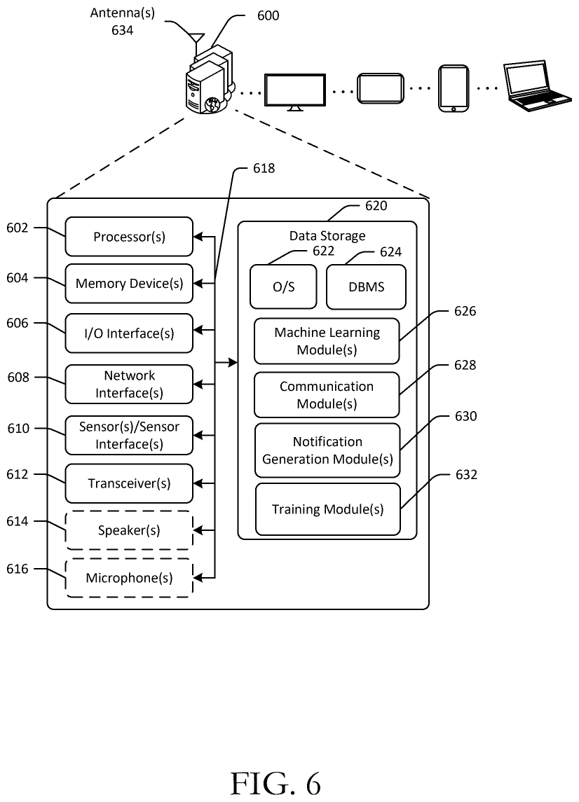

FIG. 6 is a schematic block diagram of an illustrative remote server 600 in accordance with one or more example embodiments of the disclosure. The remote server 600 may include any suitable computing device capable of receiving and/or generating data including, but not limited to, a mobile device such as a smartphone, tablet, e-reader, wearable device, or the like; a desktop computer; a laptop computer; a content streaming device; a set-top box; or the like. The remote server 600 may correspond to an illustrative device configuration for the computer systems discussed with respect to FIGS. 1-5.

The remote server 600 may be configured to communicate via one or more networks with one or more servers, search engines, user devices, or the like. In some embodiments, a single remote server or single group of remote servers may be configured to perform more than one type of correlation and/or machine learning functionality.

Example network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the remote server 600 may include one or more processors (processor(s)) 602, one or more memory devices 604 (generically referred to herein as memory 604), one or more input/output (I/O) interface(s) 606, one or more network interface(s) 608, one or more sensors or sensor interface(s) 610, one or more transceivers 612, one or more optional speakers 614, one or more optional microphones 616, and data storage 620. The remote server 600 may further include one or more buses 618 that functionally couple various components of the remote server 600. The remote server 600 may further include one or more antenna(s) 634 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 618 may include at least one of a system bus, a memory bus, an address bus, or a message bus, and may permit exchange of information (e.g., data (including computer-executable code), signaling, etc.) between various components of the remote server 600. The bus(es) 618 may include, without limitation, a memory bus or a memory controller, a peripheral bus, an accelerated graphics port, and so forth. The bus(es) 618 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 604 of the remote server 600 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 604 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 604 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 620 may include removable storage and/or non-removable storage including, but not limited to, magnetic storage, optical disk storage, and/or tape storage. The data storage 620 may provide non-volatile storage of computer-executable instructions and other data. The memory 604 and the data storage 620, removable and/or non-removable, are examples of computer-readable storage media (CRSM) as that term is used herein.

The data storage 620 may store computer-executable code, instructions, or the like that may be loadable into the memory 604 and executable by the processor(s) 602 to cause the processor(s) 602 to perform or initiate various operations. The data storage 620 may additionally store data that may be copied to memory 604 for use by the processor(s) 602 during the execution of the computer-executable instructions. Moreover, output data generated as a result of execution of the computer-executable instructions by the processor(s) 602 may be stored initially in memory 604, and may ultimately be copied to data storage 620 for non-volatile storage.

More specifically, the data storage 620 may store one or more operating systems (O/S) 622; one or more database management systems (DBMS) 624; and one or more program module(s), applications, engines, computer-executable code, scripts, or the like such as, for example, one or more machine learning module(s) 626, one or more communication module(s) 628, one or more notification generation module(s) 630, and/or one or more training module(s) 632. Some or all of these module(s) may be sub-module(s). Any of the components depicted as being stored in data storage 620 may include any combination of software, firmware, and/or hardware. The software and/or firmware may include computer-executable code, instructions, or the like that may be loaded into the memory 604 for execution by one or more of the processor(s) 602. Any of the components depicted as being stored in data storage 620 may support functionality described in reference to correspondingly named components earlier in this disclosure.

The data storage 620 may further store various types of data utilized by components of the remote server 600. Any data stored in the data storage 620 may be loaded into the memory 604 for use by the processor(s) 602 in executing computer-executable code. In addition, any data depicted as being stored in the data storage 620 may potentially be stored in one or more datastore(s) and may be accessed via the DBMS 624 and loaded in the memory 604 for use by the processor(s) 602 in executing computer-executable code. The datastore(s) may include, but are not limited to, databases (e.g., relational, object-oriented, etc.), file systems, flat files, distributed datastores in which data is stored on more than one node of a computer network, peer-to-peer network datastores, or the like. In FIG. 6, the datastore(s) may include, for example, historical electronic communication information, manual feedback information, user profile information, and other information.

The processor(s) 602 may be configured to access the memory 604 and execute computer-executable instructions loaded therein. For example, the processor(s) 602 may be configured to execute computer-executable instructions of the various program module(s), applications, engines, or the like of the remote server 600 to cause or facilitate various operations to be performed in accordance with one or more embodiments of the disclosure. The processor(s) 602 may include any suitable processing unit capable of accepting data as input, processing the input data in accordance with stored computer-executable instructions, and generating output data. The processor(s) 602 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 602 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 602 may be capable of supporting any of a variety of instruction sets.

Referring now to functionality supported by the various program module(s) depicted in FIG. 6, the machine learning module(s) 626 may include computer-executable instructions, code, or the like that responsive to execution by one or more of the processor(s) 602 may perform functions including, but not limited to, determining training data sets, determining model accuracy, generating one or more machine learning models or algorithms, determining various score values, determining text, and the like.

The communication module(s) 628 may include computer-executable instructions, code, or the like that responsive to execution by one or more of the processor(s) 602 may perform functions including, but not limited to, communicating with one or more devices, for example, via wired or wireless communication, communicating with remote servers, communicating with remote datastores, sending or receiving notifications or search queries/manual review results, communicating with cache memory data, and the like.

The notification generation module(s) 630 may include computer-executable instructions, code, or the like that responsive to execution by one or more of the processor(s) 602 may perform functions including, but not limited to, generating one or more notifications, determining manual review output values, determining timing of notifications, determining or analyzing text or audio files, identifying certain portions of communications, and the like.

The training module(s) 632 may include computer-executable instructions, code, or the like that responsive to execution by one or more of the processor(s) 602 may perform functions including, but not limited to, receiving feedback signals, aggregating feedback data, generating datasets, and the like.

Referring now to other illustrative components depicted as being stored in the data storage 620, the O/S 622 may be loaded from the data storage 620 into the memory 604 and may provide an interface between other application software executing on the remote server 600 and hardware resources of the remote server 600. More specifically, the O/S 622 may include a set of computer-executable instructions for managing hardware resources of the remote server 600 and for providing common services to other application programs (e.g., managing memory allocation among various application programs). The O/S 622 may include any operating system now known or which may be developed in the future including, but not limited to, any server operating system, any mainframe operating system, or any other proprietary or non-proprietary operating system.

The DBMS 624 may be loaded into the memory 604 and may support functionality for accessing, retrieving, storing, and/or manipulating data stored in the memory 604 and/or data stored in the data storage 620. The DBMS 624 may use any of a variety of database models (e.g., relational model, object model, etc.) and may support any of a variety of query languages. The DBMS 624 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like. In those example embodiments in which the remote server 600 is a mobile device, the DBMS 624 may be any suitable light-weight DBMS optimized for performance on a mobile device.

Referring now to other illustrative components of the remote server 600, the input/output (I/O) interface(s) 606 may facilitate the receipt of input information by the remote server 600 from one or more I/O devices as well as the output of information from the remote server 600 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the remote server 600 or may be separate. The I/O devices may further include, for example, any number of peripheral devices such as data storage devices, printing devices, and so forth.

The I/O interface(s) 606 may also include an interface for an external peripheral device connection such as universal serial bus (USB), FireWire, Thunderbolt, Ethernet port or other connection protocol that may connect to one or more networks. The I/O interface(s) 606 may also include a connection to one or more of the antenna(s) 634 to connect to one or more networks via a wireless local area network (WLAN) (such as Wi-Fi) radio, Bluetooth, ZigBee, and/or a wireless network radio, such as a radio capable of communication with a wireless communication network such as a Long Term Evolution (LTE) network, WiMAX network, 3G network, ZigBee network, etc.

The remote server 600 may further include one or more network interface(s) 608 via which the remote server 600 may communicate with any of a variety of other systems, platforms, networks, devices, and so forth. The network interface(s) 608 may enable communication, for example, with one or more wireless routers, one or more host servers, one or more web servers, and the like via one or more of networks.

The antenna(s) 634 may include any suitable type of antenna depending, for example, on the communications protocols used to transmit or receive signals via the antenna(s) 634. Non-limiting examples of suitable antennas may include directional antennas, non-directional antennas, dipole antennas, folded dipole antennas, patch antennas, multiple-input multiple-output (MIMO) antennas, or the like. The antenna(s) 634 may be communicatively coupled to one or more transceivers 612 or radio components to which or from which signals may be transmitted or received.

As previously described, the antenna(s) 634 may include a cellular antenna configured to transmit or receive signals in accordance with established standards and protocols, such as Global System for Mobile Communications (GSM), 3G standards (e.g., Universal Mobile Telecommunications System (UMTS), Wideband Code Division Multiple Access (W-CDMA), CDMA 2000, etc.), 4G standards (e.g., Long-Term Evolution (LTE), WiMax, etc.), direct satellite communications, or the like.

The antenna(s) 634 may additionally, or alternatively, include a Wi-Fi antenna configured to transmit or receive signals in accordance with established standards and protocols, such as the IEEE 802.11 family of standards, including via 2.4 GHz channels (e.g., 802.11b, 802.11g, 802.11n), 5 GHz channels (e.g., 802.11n, 802.11ac), or 60 GHz channels (e.g., 802.11ad). In alternative example embodiments, the antenna(s) 634 may be configured to transmit or receive radio frequency signals within any suitable frequency range forming part of the unlicensed portion of the radio spectrum.

The antenna(s) 634 may additionally, or alternatively, include a GNSS antenna configured to receive GNSS signals from three or more GNSS satellites carrying time-position information to triangulate a position therefrom. Such a GNSS antenna may be configured to receive GNSS signals from any current or planned GNSS such as, for example, the Global Positioning System (GPS), the GLONASS System, the Compass Navigation System, the Galileo System, or the Indian Regional Navigational System.

The transceiver(s) 612 may include any suitable radio component(s) for—in cooperation with the antenna(s) 634—transmitting or receiving radio frequency (RF) signals in the bandwidth and/or channels corresponding to the communications protocols utilized by the remote server 600 to communicate with other devices. The transceiver(s) 612 may include hardware, software, and/or firmware for modulating, transmitting, or receiving—potentially in cooperation with any of antenna(s) 634—communications signals according to any of the communications protocols discussed above including, but not limited to, one or more Wi-Fi and/or Wi-Fi direct protocols, as standardized by the IEEE 802.11 standards, one or more non-Wi-Fi protocols, or one or more cellular communications protocols or standards. The transceiver(s) 612 may further include hardware, firmware, or software for receiving GNSS signals. The transceiver(s) 612 may include any known receiver and baseband suitable for communicating via the communications protocols utilized by the remote server 600. The transceiver(s) 612 may further include a low noise amplifier (LNA), additional signal amplifiers, an analog-to-digital (A/D) converter, one or more buffers, a digital baseband, or the like.

The sensor(s)/sensor interface(s) 610 may include or may be capable of interfacing with any suitable type of sensing device such as, for example, inertial sensors, force sensors, thermal sensors, and so forth. Example types of inertial sensors may include accelerometers (e.g., MEMS-based accelerometers), gyroscopes, and so forth.

The optional speaker(s) 614 may be any device configured to generate audible sound. The optional microphone(s) 616 may be any device configured to receive analog sound input or voice data.

It should be appreciated that the program module(s), applications, computer-executable instructions, code, or the like depicted in FIG. 6 as being stored in the data storage 620 are merely illustrative and not exhaustive and that processing described as being supported by any particular module may alternatively be distributed across multiple module(s) or performed by a different module. In addition, various program module(s), script(s), plug-in(s), Application Programming Interface(s) (API(s)), or any other suitable computer-executable code hosted locally on the remote server 600, and/or hosted on other computing device(s) accessible via one or more networks, may be provided to support functionality provided by the program module(s), applications, or computer-executable code depicted in FIG. 6 and/or additional or alternate functionality. Further, functionality may be modularized differently such that processing described as being supported collectively by the collection of program module(s) depicted in FIG. 6 may be performed by a fewer or greater number of module(s), or functionality described as being supported by any particular module may be supported, at least in part, by another module. In addition, program module(s) that support the functionality described herein may form part of one or more applications executable across any number of systems or devices in accordance with any suitable computing model such as, for example, a client-server model, a peer-to-peer model, and so forth. In addition, any of the functionality described as being supported by any of the program module(s) depicted in FIG. 6 may be implemented, at least partially, in hardware and/or firmware across any number of devices.

It should further be appreciated that the remote server 600 may include alternate and/or additional hardware, software, or firmware components beyond those described or depicted without departing from the scope of the disclosure. More particularly, it should be appreciated that software, firmware, or hardware components depicted as forming part of the remote server 600 are merely illustrative and that some components may not be present or additional components may be provided in various embodiments. While various illustrative program module(s) have been depicted and described as software module(s) stored in data storage 620, it should be appreciated that functionality described as being supported by the program module(s) may be enabled by any combination of hardware, software, and/or firmware. It should further be appreciated that each of the above-mentioned module(s) may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other module(s). Further, one or more depicted module(s) may not be present in certain embodiments, while in other embodiments, additional module(s) not depicted may be present and may support at least a portion of the described functionality and/or additional functionality. Moreover, while certain module(s) may be depicted and described as sub-module(s) of another module, in certain embodiments, such module(s) may be provided as independent module(s) or as sub-module(s) of other module(s).

Program module(s), applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

1. A method comprising:
determining, by one or more computer processors coupled to memory, a first flagged electronic communication using a first model, wherein the first flagged electronic communication is flagged due to presence of a phrase;
determining, using a second machine learning model, a first false positive score of the first electronic communication;
determining that the first false positive score is less than or equal to a first threshold;
generating a manual review notification for the first flagged electronic communication;
determining a manual review output signal associated with the first flagged electronic communication; and
causing the second machine learning model to be retrained based at least in part on the manual review output signal.

2. The method of claim 1, further comprising:
determining that the manual review output signal indicates the first flagged electronic communication is a false positive.

3. The method of claim 1, further comprising:
determining a second flagged electronic communication using the first model, wherein the first model is a lexicon-based rules model;
determining, using the second machine learning model, a second false positive score of the second electronic communication;
determining that the second false positive score is greater than the first threshold; and
generating a false positive notification for the second flagged electronic communication.

4. The method of claim 3, wherein the first threshold is configurable based at least in part on the phrase.

5. The method of claim 4, further comprising:
determining the first threshold based at least in part on words in the phrase.

6. The method of claim 4, further comprising:
determining the first threshold based at least in part on a user profile associated with the first flagged electronic communication.

7. The method of claim 4, further comprising:
determining the first threshold based at least in part on a number of flagged electronic communications queued for manual review.

8. The method of claim 1, wherein the first model is a first machine learning model, the method further comprising:
determining a first set of manually reviewed positive flagged electronic communications;
generating a set of synthetic phrases based at least in part on the first set of manually reviewed positive flagged electronic communications; and
training the first machine learning model using a blended data set comprising the first set of manually reviewed positive flagged electronic communications and the set of synthetic phrases.

9. The method of claim 8, wherein the set of synthetic phrases is generated using a large language model.

10. A device comprising:
memory that stores computer-executable instructions; and
at least one processor configured to access the memory and execute the computer-executable instructions to:
determine a first flagged electronic communication using a first machine learning model, wherein the first flagged electronic communication is flagged due to presence of a phrase;
determine, using a second machine learning model, a first false positive score of the first electronic communication;
determine that the first false positive score is less than or equal to a first threshold;
generate a manual review notification for the first flagged electronic communication;
determine a manual review output signal associated with the first flagged electronic communication; and
cause the second machine learning model to be retrained based at least in part on the manual review output signal.

11. The device of claim 10, wherein the at least one processor is further configured to access the memory and execute the computer-executable instructions to:
determine that the manual review output signal indicates the first flagged electronic communication is a false positive.

12. The device of claim 10, wherein the at least one processor is further configured to access the memory and execute the computer-executable instructions to:
determine a second flagged electronic communication using the first machine learning model;
determine, using the second machine learning model, a second false positive score of the second electronic communication;
determine that the second false positive score is greater than the first threshold; and
generate a false positive notification for the second flagged electronic communication.

13. The device of claim 12, wherein the first threshold is configurable based at least in part on the phrase.

14. The device of claim 13, wherein the at least one processor is further configured to access the memory and execute the computer-executable instructions to:
determine the first threshold based at least in part on words in the phrase.

15. The device of claim 13, wherein the at least one processor is further configured to access the memory and execute the computer-executable instructions to:
determine the first threshold based at least in part on a user profile associated with the first flagged electronic communication.

16. The device of claim 13, wherein the at least one processor is further configured to access the memory and execute the computer-executable instructions to:
determine the first threshold based at least in part on a number of flagged electronic communications queued for manual review.

17. The device of claim 10, wherein the at least one processor is further configured to access the memory and execute the computer-executable instructions to:
determine a first set of manually reviewed positive flagged electronic communications;
generate a set of synthetic phrases based at least in part on the first set of manually reviewed positive flagged electronic communications; and
train the first machine learning model using a blended data set comprising the first set of manually reviewed positive flagged electronic communications and the set of synthetic phrases.

18. The device of claim 17, wherein the set of synthetic phrases is generated using a large language model.

19. A method comprising:
determining, by one or more computer processors coupled to memory, a first flagged electronic communication using a first machine learning model, wherein the first flagged electronic communication is flagged due to presence of a phrase;
determining, using a second machine learning model, a first false positive score of the first electronic communication;
determining that the first false positive score is less than or equal to a first threshold;
generating a manual review notification for the first flagged electronic communication;
determining a manual review output signal associated with the first flagged electronic communication;
determining that the manual review output signal indicates the first flagged electronic communication is a false positive;
causing the second machine learning model to be retrained based at least in part on the manual review output signal;
determining a second flagged electronic communication using the first machine learning model;
determining, using the second machine learning model, a second false positive score of the second electronic communication;
determining that the second false positive score is greater than the first threshold; and
generating a false positive notification for the second flagged electronic communication.

20. The method of claim 19, wherein the first threshold is determined based at least in part on at least one of: the phrase, words in the phrase, a user profile associated with the first flagged electronic communication, or a number of flagged electronic communications queued for manual review.
